(19) United States
(12) Patent Application Publication
(10) Pub. No.: US 2011/0106517 A1
(43) Pub. Date: May 5, 2011

(54) METHOD OF SIMULATING AN ELECTRONIC CIRCUIT COMPRISING AT LEAST ONE ANALOGUE PART WITH A POWER SPECTRAL DENSITY

(75) Inventor: Daniel Saias, Grenoble (FR)

(73) Assignee: ASYGN, MONTBONNOT-SAINT-MARTIN (FR)

(21) Appl. No.: 12/995,589

(22) PCT Filed: Jun. 8, 2009
(86) PCT No.: PCT/FR2009/000672

§ 371 Date: Dec. 1, 2010

(30) Foreign Application Priority Data
Jun. 10, 2008 (FR) 08/03216

(51) Int. Cl. G06F 17/50

(52) U.S. Cl. 703/14

(57) ABSTRACT

An electronic circuit, comprising at least an analog part, subjected to predefined input signals in the time domain, is broken down into at least one modeled elementary block. The input signal is transformed into a simulation signal which comprises at least one useful signal component representative of the spectral power density of the input signal. Application to an input of the simulation signal circuit is simulated. The useful component of the simulated signal is computed on output of each successive block. The useful component of the simulated signal output from the circuit is compared with at least one predefined signal to test at least one characteristic of the circuit. A noise component can be introduced in a simulation signal or in the output signal of a block passed through.

### BACKGROUND OF THE INVENTION

The invention relates to a method for simulating an electronic circuit comprising at least an analog part, subjected to at least one predefined signal in the time or frequency domain coming from at least one signal emission source, the circuit being broken down into at least one modeled elementary block.

### STATE OF THE ART

When designing an integrated circuit, the characteristics of the circuit being designed have to be known as quickly as possible in order to correct possible errors or to tune important parameters of the circuit. Conventionally, knowledge of the characteristics of the integrated circuit is obtained by means of simulation methods which, for a signal transiting via the circuit, simulate the different transformations induced by the integrated circuit and enable the characteristics of the output signal to be estimated. In this way, an integrated circuit is characterized by means of one or more predefined signals which pass through the latter. Simulation methods among other things enable the architecture of the integrated circuit to be designed and/or the validity of the future circuit to be verified.

In conventional manner, the circuit is broken down into a plurality of functional blocks via which a study signal transits. Each block presents a model which is known or estimated and which modifies the signal. In this way, the method will simulate the successive modifications of the signal from input of the latter to the integrated circuit and as the latter passes progressively through the different blocks.

In general manner, simulations which concern integrated circuits, i.e. more or less complex sets of functions, are characterized by computing times that are long, which prevents an exhaustive study of all the parameters of the integrated circuit. Moreover, if the integrated circuit is of analog type, i.e. if it processes continuous physical quantities (as opposed to processing of discrete digital data which only manages discrete data), the computing times are even longer, which greatly penalizes the reactivity of the design phase.

In conventional manner, three types of simulation methods exist. First simulation methods are based on electric simulation of the integrated circuit, this type of simulation presenting simulation times which are excessively long rendering this approach unusable.

Simulation methods also exist which consist in replacing the signal input to the integrated circuit by a sine wave. In this way, the characteristics induced by the different components of the circuit, for example noise, are also defined by sine waves the frequency whereof is a combination of the harmonies of the frequencies present. This method has the advantage of being fast, but it only very partially meets the requirements of designers, as too many approximations are made. This method can be carried out at electric level (at the level of the transistor) or at system level.

The third type of method consists in describing the signals which are processed in the integrated circuit on a time basis, for example in a base band. This method is slow as the signal and therefore the data (symbols) it contains have to be fully described. This description has to be performed point-to-point in time-based manner which involves processing a large quantity of information. Furthermore, it is also necessary to perform a large number of simulations which will enable the mean characteristics of the signal to be computed. It is also important to oversample the signal to take account of non-linear effects which may occur in pin-point manner in the circuit.

Thus, in schematic manner, simulation techniques are divided into two categories. The first category provides relatively precise information, but the price to pay is long computing times. The second category enables fast computations, but the resulting information may contain errors due to the approximations which are made in the computing phases.

### OBJECT OF THE INVENTION

The object of the invention is to evaluate one or more characteristics of an integrated circuit in quick and reliable manner by means of a signal which transits via the integrated circuit that is being designed.

The method according to the invention is characterized by the appended claims and in particular by the fact that the predefined signal comprising at least one useful component having a predefined spectral power density, the method comprises simulation of application of a simulation signal formed by at least one useful component representative of said spectral power density of the predefined signal on an input of at least one block of the circuit, and by the fact that the method comprises at least computation of the useful component of an output signal of the circuit and comparison of the useful component of the output signal of the circuit with a predefined signal to test at least one characteristic of said circuit.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 schematically represents the breakdown of a circuit according to the invention,

FIG. 2 schematically represents the template sub-component of a useful or noise component of a signal according to the invention,

FIGS. 3 and 4 schematically represent the amplitude and phase of a form sub-component of a useful or noise component of a signal according to the invention,

FIG. 5 schematically represents comparison of a useful component of a signal with respect to a desired theoretical signal according to the invention.

### DESCRIPTION OF A PREFERRED EMBODIMENT OF THE INVENTION

The method for simulating an integrated circuit according to the invention enables at least one technical characteristic of a circuit to be tested by means of analysis, on circuit output, of at least one signal representative of a signal which has transited via the circuit either from an input of the circuit or from a generator which is included in the circuit.

The integrated circuit in design phase is an analog circuit or a mixed analog/digital circuit. The circuit therefore comprises at least an analog part which is used with time-based signals which evolve continuously with time. The signal which transits via the circuit belongs to the time domain. The time signal may be perfect and only comprise a useful component, but it can also comprise at least one noise component.

The analog input signal is for example a “telecom” type signal such as GSM (Global System Mobile Communications), WDMA (Wideband Code Division Multiple Access), DTTV (Digital Terrestrial Television), WIMAX (Worldwide Interoperability for Microwave Access) or WIFI (Wireless Fidelity) signals. However, the input signal can also be a signal emitted by a sensor, for example a curve typical of an encephalogram or an automobile vibration.

A useful component and possibly at least one noise component which have the form of a spectral power density can be determined from the time signal to be integrated in a simulation signal. It is this simulation signal which transits via the circuit, or at least via a part of the circuit, which enables the circuit to be characterized.

In practical manner, the time signal is emitted by means of an emission source which may not be perfect and which then introduces a noise component. The simulation signal then comprises at least one noise component on its input to the circuit. If the noise of the signal emitted is perfectly characterized, its noise component can be broken down into several components corresponding to different spectral templates, for example a white noise or a 1/f noise.

The simulation signal which enables the circuit to be characterized comprises at least one useful component which is representative of the spectral power density of the input signal which is of analog type. In this manner, the input signal which is a time domain signal is transformed into a simulation signal which is a representation of the power of the time signal in the frequency domain. Conventionally, transformation of the time signal into a spectral power density is performed by means of the square root of the mean of the square of the Fourier transform modulus of the time signal. The useful components and the noise components if any are therefore represented as V²/Hz or as V/\sqrt{Hz} if the signal is expressed in voltage, typically an electric signal. The spectral power density can be expressed for example as Pa/\sqrt{Hz} or by any other unit which defines the time domain signal.

Typically, the spectral power density describes how the power is distributed according to the frequency in the corresponding time signal. It is important to point out that the time signal cannot be reconstructed from the spectral power density alone as the time information is lost.

In this way, fine time description of the signal is eliminated which, compared with a simulation method according to the prior art, also enables repetition of the simulations to be eliminated to directly access statistical values characterizing the impact of the circuit on the signal transiting via the latter.

This transformation of the time signal into a frequency signal also enables a signal to be described on a very broad band without there being any repercussions on the computing time.

The integrated circuit, associated with the simulation signal, is broken down and represented by at least one elementary block, typically by a plurality of elementary blocks, which are connected to one another according to a predefined layout representative of the initial circuit operating in the time domain.

In conventional manner, the integrated circuit, and likewise the plurality of elementary blocks which represent the latter, comprises at least one signal input terminal and at least one signal output terminal. In conventional manner, the signal is always output from the block via one or more output terminals and is always input to another block via one or more input terminals. The elementary blocks can be connected in series, but also according to a more complex layout which meets the foregoing criteria. In this way, the integrated circuit is transposed into a plurality of elementary blocks which are representative of the initial circuit. Each elementary block is modeled by at least one transit function which will modify any signal which passes through the elementary block. It is also possible for the circuit to be modeled by a single block, for example in the case where the circuit is composed of a single filter.

It is also possible for the circuit or an elementary block not to comprise any input blocks. In this case, a signal is generated directly by the circuit or the block, which can be the case for example of a clock. As previously, the circuit is characterized by means of the signal emitted by the generator and which transits within the circuit. The input of the circuit is then considered to be formed by the block which contains the signal generator.

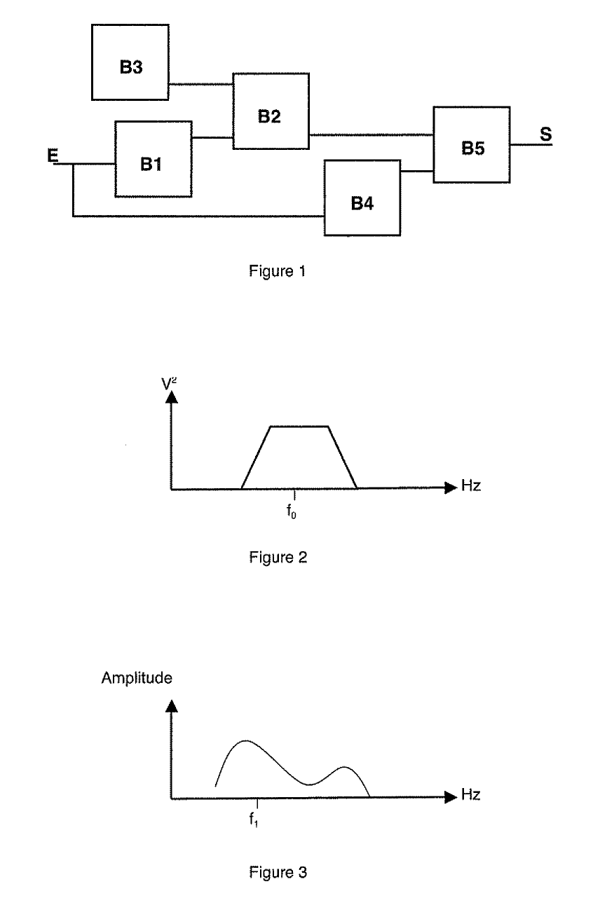

For example purposes illustrated in FIG. 1, a circuit comprising an input terminal and an output terminal is represented by a set of five elementary blocks. The circuit input correspond to the input of first block B1. The output of first block B1 is connected to a first input of second block B2. A second input of second block 132 is connected to a generator block B3 which emits for example a clock signal. The signal reaching the input terminal also reaches the input terminal of a fourth block B4 by branch-off. The output terminals of the second and fourth blocks are respectively connected to first and second input terminals of a fifth block B5. The output terminal of fifth block 135 corresponds to the output terminal of the circuit. In such a circuit, a simulation signal E is simulated on input to the circuit and an output signal S of the circuit is computed on output from the circuit.

The elementary blocks representing the circuit are subjected to at least one simulation signal which will transit via the different elementary blocks. The simulation signal is broken down into several components including at least one useful component. In conventional manner, the circuit also comprises one or more components representative of the noise. Conventionally, the signal on input of the circuit can be perfect and only contain a useful component.

The method simulates application of the simulation signal to the input of the circuit and for each block passed through computes an output signal of the block which schematically represents the modification of the simulation signal by means of at least one transit function representative of the elementary block passed through. In conventional manner, a simulation signal is thereby simulated on input of a block which gives an output signal on output, this output signal then becoming the simulation signal of the block which follows on from this block in the integrated circuit.

Testing of at least one of the characteristics of the circuit is achieved by means of the output signal of the circuit. This characterization is performed by comparing the useful component of the output signal of the circuit with a predefined signal, for example a reference useful component, one or more noise components, or the useful component on input to the circuit.

As specified in the foregoing, each elementary block which constitutes the circuit is modeled by at least one transit function. This transit function is typically a mathematical or logic function which describes the relation linking the input signal with the signal which is output from the elementary block. The transit function can comprise one or more components. For example, its components can modify the amplitude of the signal, introduce a frequency shift or introduce a phase shift. The transit function or one of its components can be applied in identical manner to the whole frequency spectrum or have a variable relation according to the frequency. The transit function can also introduce an additional noise signal which is a function of the (useful and/or noise) signal or not on the input of this block. This additional noise component is then integrated in the output signal of the block and is modified by the blocks which follow until the output signal of the circuit is obtained. Advantageously, if the elementary block comprises several input terminals and/or several output terminals, the transit function can be specific to the input and/or output terminal.

If the elementary block is considered as being perfect, the elementary block comprises a single transit function, and the simulation signal components are simply modified taking account of the transit function which characterizes the elementary block passed through. Thus, for example purposes, a simulation signal which contains a useful component and two noise components sees these three components modified by the transit function of the elementary block passed through. For example, if the elementary block passed through is of gain type, each of the components of the simulation signal sees its amplitude multiplied by the gain of the elementary block.

If the elementary block is not considered as being perfect, one or more parameterized noise components can be added to the already existing components of the simulation signal when the latter passes through the block. As before, the components of the simulation signal on input to the elementary block are modified by the transit function of the block passed through. The characteristics of the added noise components can be defined from the components on input of the signal. It is also possible for the characteristics of the new noise components to be independent from the simulation signal on input to the elementary block. Thus for example purposes, if the elementary block of gain type used in the previous example is for example not perfect, two new noise components can be added to the simulation signal. A first component can be linked to the input signal by means of an additional transit function, whereas the second component is independent, for example a white noise which originates from a power supply. This results, on output from the elementary block, in the simulation signal now comprising one useful component and four noise components and in all the components being input to the next elementary blocks passed through.

In a privileged embodiment, the simulation signal is broken down into a useful component and possibly a plurality of noise components. Each useful and noise component is then broken down into a plurality of sub-components, typically a template sub-component, a frequency shift sub-component, and a form sub-component. However it is also possible to use another description of the simulation signal which enables simulation of the latter from an input of the circuit through to output from the circuit taking the information provided by all the elementary blocks passed through into account.

The template sub-component typically represents the spectral density of the component considered on emission. The template sub-component does not vary as the signal transits progressively via the different elementary blocks. The template sub-component can advantageously be chosen from a library of characteristic spectral power densities. As illustrated in FIG. 2, the template sub-component represents the power distribution versus the frequency around an arbitrary frequency f₀, i.e. without taking account of the actual frequency of the signal. Typically, the template sub-component only keeps a set representative of points which describe the representation of the power according to the frequency. The template can be limited to one or more precise frequency ranges or to a predefined number of frequencies which correspond to the highest powers, for example the ten highest powers. In advantageous manner, the number of (power, frequency) pairs which defines the template sub-component can vary from one elementary block to the other. Distribution of the pairs can also be variable in order to limit for example data loss in a particular frequency range or the amount of data to be processed.

The frequency shift sub-component is associated with the template sub-component and enables the frequency centering of the template sub-component to be known. The frequency shift sub-component thereby enables it to be known whether two identical template sub-component signals have common frequencies or not.

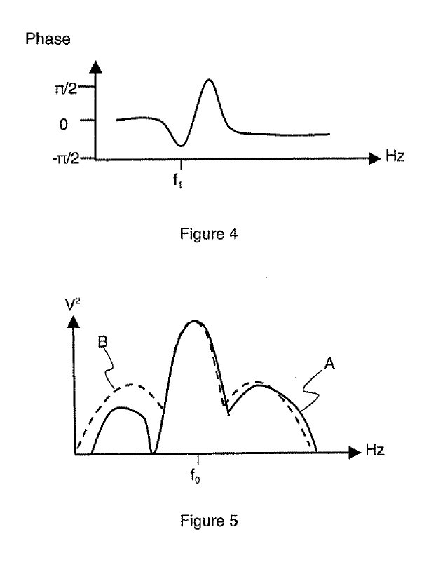

The simulation signal also contains a form sub-component which keeps the information relating to the amplitude and phase alterations made to the template sub-component. The form sub-component is a real function with complex values and is modified by the transit functions of the elementary blocks which have been passed through. The form sub-component thereby keeps the historical account of the transformations of the component whereas the template sub-component keeps the form of the component on emission. As illustrated in FIGS. 3 and 4, the form sub-component only represents the amplitude and phase (without units) versus the frequency.

Each component of the signal is thus described by means of these three sub-components.

The signal advantageously also comprises a signature sub-component relative to the source which emitted the signal, for example an antenna, a generator, an elementary block. The signature sub-component is not modified as it passes via the different elementary blocks. Thus, in conventional manner, the useful component has a signature associated with an antenna or a generator whereas the noise components can be associated with a power supply, an antenna called “parasite antenna”, or an elementary block.

The simulation signal which transits via the circuit, for example a signal of GSM (Global System for Mobile Communications) or WDMA (Wideband Code Division Multiple Access) type, is thus described as a sum of elementary signals assigned with the transformations linked to the transit functions which it has undergone since it was generated in the circuit to give the output signal. Such a signal can be of the form

$$S ( f ) = {\sum }_{k , l , m} {TF}_{k , l , m} ( f ) \cdot {SE}_{k , l} ( f - {df}_{k , l , m} )$$

in which
TF represents the form sub-components,
the index k differentiates the useful and noise components,
the index l differentiates the template sub-components which are identical but of different signatures,
the index m differentiates the template sub-components which are identical, of the same origin, but which have undergone different frequency shifts,
SE represents the template sub-component,
df represents the frequency shift, i.e. the frequency shift sub-component.

In practical manner, the useful component of the signal is represented by k=l=m=1.

In this way, the characteristics of the signal, its useful and noise components, are computed as the signal passes via the different elementary blocks from the input terminal of the circuit through to its output terminal. Furthermore, the circuit is described by the juxtaposition of a plurality of elementary blocks which present simple functions enabling the progression of the simulation signal as the latter transits through the circuit to be monitored easily.

By means of this transformation of the time signal into a spectral power density, transformation of the input simulation signal is performed by juxtaposition of the different functions which correspond to the different elementary blocks. It is then possible to monitor the progression of the signals between the different blocks easily and to determine the origin of the elementary signals which are mainly responsible for large variations of certain characteristics, for example degradation of the signal-to-noise ratio.

On output of the circuit, the simulation signal comprises a component representative of the useful signal and at least one component representative of the noise which have undergone the transformations linked to the elementary blocks of the circuit. The power ratio between the useful signal can then be compared with a predefined signal on at least a part of the useful signal, i.e. over at least a predefined frequency range.

As illustrated in FIG. 5, the useful component of the simulation signal can be compared on output of the circuit (plot A) with a spectral power density which is representative of specifications (plot B) the circuit has to comply with. The useful component of the simulation signal can also be compared on output of the circuit with the useful component of the signal on input of the circuit so as to know the deformation of the signal introduced by the circuit. The useful component of the simulation signal can also be compared with at least one cause of noise. The useful component of the simulation signal can also be compared with all the noise components. This then results in the signal-to-noise ratio being able to be quantified in simple and rapid manner and, in this signal-to-noise ratio, it being for example possible to discriminate which block is the major cause of noise and what type of noise is mainly present in the circuit.

Advantageously, the signal-to-noise ratio measured from the useful and noise signal components is used to compute the error rate measured on receipt of a digital transmission. The error rate can be computed by means of a numerical relation which is a function of the time signal used with the circuit. For example purposes, formulas are proposed in the fascicle of the 802.15.4 standard defined by the IEEE Computer Society organization (“IEEE Standard for Information technology—Telecommunication and information exchange between systems—Local and metropolitan area networks—Specific requirements”, IEEE Std 802.15.4™-2006, p 275-282).

The difference between the desired useful component and the computed useful component with respect to the desired useful component can also be compared to compute the error vector magnitude which enables the performances of a radiofrequency transmitter or receiver to be quantified.

In a privileged embodiment, the data contained in the template and signature sub-components is used to differentiate processing, i.e. the transit function, of at least two signals which are input to the same elementary block. Advantageously, the elementary block transit function is different if the signals on input are at least partially correlated or non-correlated. This processing difference makes for finer analysis.

As a non-represented example, the elementary block is of “sum” type and comprises two input terminals associated with two simulation signals E1 and E2. The output signal of block S represents the sum of the two input signals E1 and E2.

If all the components of the two signals E1 and E2, on input of the summer block, each present at least one signature sub-component different from that of the others, the simulation signal comprises all the components of the two input signals on output of the block. As a signature sub-component cannot disappear in the simulation method, output signal S comprises all the components of the input signals. There is then a power sum of the input signals, each of the components of which are found in the output signal, each component having been kept.

As a non-represented example, if a first input signal E1 comprising a useful component EU1 and noise component EB1 and a second input signal E2 comprising a useful component EU2 and noise component EB2 are applied to the input of the summer block, signal S comprises the two useful components EU1 and EU2 and the two noise components EB1 and EB2 on output. The useful component of the output signal is subsequently selected according to the input signal to be studied, i.e. the source which is representative of the characteristic of the circuit sought for. The remaining useful component is then declared as being a noise component.

If among the components of two signals E1 and E2, on input to the summer block, components exist which share the same signature sub-components, template sub-components and frequency reference sub-components, signal S on output of the block comprises the aggregation of this component. The other components are processed as in the previous case. When this aggregation takes place, the two components on input only give a single component on output, the template and signature sub-components being identical they are conserved in the output signal in a single component. As far as the form sub-component is concerned, the phase and amplitude data contained in each of the initial form sub-components are taken into account in processing thereof.

Thus, in schematic manner, for two components of two signals which have identical template and signature sub-components, summing of the power form sub-components is performed (simple summing of the amplitudes) if the frequency reference sub-components are different and summing taking account of the phase is performed if the frequency reference sub-components are identical. If the frequency reference sub-components are different, the output signal advantageously comprises each of the components of the input signal as there is not really any modification of the form sub-component.

In an alternative embodiment, improvements can be made in the comparison of input signals E1 and E2 which each contain a component with identical signature and template sub-components. If the frequency reference sub-components are different but overlapping of the two templates occurs for certain frequencies, it is in fact interesting to take account of the phase when adding form sub-components for the overlapping frequencies.

Advantageously, in this embodiment, modification of the form sub-components is performed taking account of a predefined corrective factor, the amplitude and phase. It is also possible to take account of the possible auto-correlation of signals which present a redundancy when summing the latter.

As in the foregoing, for the non-common frequencies of each of the components, there is only amplitude modification (i.e. power modification) of the form sub-components, data relative to the phase of the signal is not take into account and only summing of the power amplitudes is performed.

For example purposes, first and second input signals E1 and E2 are applied to two inputs of a summer block which presents a signal S on output. First signal E1 contains one useful component EU1 and three noise components EB11, EB12 and EB13. Second input signal E2 contains one useful component and two noise components EU1, EB21 and EB22. The useful components of each of the signals have the same template sub-component G1 and originate from the same source Emett1 and the same frequency sub-component. The useful components of each of the signals have form sub-components HU1 and HU2 and frequency shift sub-components f1 and f2. This results in simulation signal S on output from the block comprising a useful component which has a template sub-component G1, a source sub-component Emett1 and a form sub-component HU1+HU2 the sum of which takes account of the phase for the frequencies common to the useful components of EU1 and EU2 and which does not take account of the phase for the other frequencies.

Furthermore, noise components EB12 and EB22 are both representative of a white noise originating from the same noise source. These two components therefore have the same signature and template sub-components. There is then aggregation of these two components of the input signals to form a component SB2 of signal S on output from the elementary block. As the other noise components have at least one signature sub-component proper, they are kept in signal S on output from the elementary block. This results in the signal on output from the elementary block containing a useful component which comes from aggregation of the useful components of signals E1 and E2, a noise component which comes from aggregation of noise components EB12 and EB22 of signals E1 and E2, and three noise components which come from components EB11, EB21 and EB13.

For example purposes, a summer block has been described in the above examples to describe the computing principles when transformation of two input signals takes place to obtain an output signal, but the same computing rules can also be used when the input signal or signals pass through any block which adds or convolutes two signals to form the output signal. These rules are applicable for example to mixing blocks or sampler blocks.

1-9. (canceled)

10. A method for simulating an electronic circuit comprising an analog part subjected to one predefined signal in the time or frequency domain:
braking down the circuit into at least one modeled elementary block,
applying a simulation signal comprising a useful component to an input of the at least one modeled elementary block of the circuit, wherein the useful component is representative of a power spectral density of the predefined signal in the time or frequency domain,
computing the useful component of an output signal of the circuit and
comparing the useful component of the output signal of the circuit with a predefined signal to test at least one characteristic of said circuit.

11. The method according to claim 10, wherein the useful component of the output signal of the circuit is compared with a signal representative of specifications with which the circuit has to comply.

12. The method according to claim 10, comprising computation of a noise component of the output signal and comparison of the useful component of the output signal of the circuit with said noise component.

13. The method according to claim 10, wherein the simulation signal comprises at least one noise component.

14. The method according to claim 10, wherein the useful component comprises at least a template sub-component, a form sub-component, and a frequency shift sub-component.

15. The method according to claim 14, wherein the useful component comprises a signature sub-component.

16. Method according to claim 10, wherein at least one of the elementary blocks introduces a noise component in the output signal of the elementary block.

17. The method according to claim 14, wherein at least two distinct simulation signals are applied to two inputs of the at least one elementary block, computing the useful component of the output signal of said block is performed by making an aggregation of the components which contain the same signature sub-components and the same template sub-components.

18. The method according to claim 17, wherein aggregation takes account of the phase of the component contained in the form sub-component for frequencies identical to each of the components.
